(19) United States
(12) Patent Application Publication
(10) Pub. No.: US 2015/0008355 A1
(43) Pub. Date: Jan. 8, 2015

(54) MIXTURE COMPOSITION CONTAINING AMINO-FUNCTIONAL SILOXANES, HYDROPHOBIC PARTICLES AND HIGH MOLECULAR WEIGHT SILICONES AND ITS USE FOR LEATHER TREATMENT

(71) Applicant: Evonik Industries AG, Essen (DE)

(72) Inventors: Christian Mund, Essen (DE); Joerg Peggau, Essen (DE)

(73) Assignee: Evonik Industries AG, Essen (DE)

(21) Appl. No.: 14/374,416

(22) PCT Filed: Dec. 18, 2012
(86) PCT No.: PCT/EP2012/075881

§ 371 Date: Jul. 24, 2014

(30) Foreign Application Priority Data
Jan. 27, 2012 (DE) 102012201167.6

(51) Int. Cl. C09G 1/16

(52) U.S. Cl. CPC C09G 1/16
USPC 252/8.57

(57) ABSTRACT

The invention relates to mixture compositions containing amino-functional siloxanes, hydrophobic particles and high molecular weight silicones and their use for leather treatment.

### FIELD OF THE INVENTION

The invention relates to mixture compositions containing amino-functional siloxanes, hydrophobic particles and high molecular weight silicones and their use for leather treatment.

### PRIOR ART

The process step of fatliquoring or hydrophobizing leather, but also the everyday caring treatment of leather is essential to the finishing and preservation of leather goods such as, for example, bags, shoes or leather apparel. The fatliquoring and treatment agents used therein have a significant effect on the properties and the utility of the final products.

The treatment agents used shall endow the leather inter alia with cleaning resistance and water-proofness but also with good properties in respect of softness, suppleness and fatness and also with lustre (“Bibliothek des Leders”, editor: Hans Herfeld, volume 4, Frankfurt 1987).

Various types of polymer have been described for the finishing and hydrophobization of leather goods. Polyolefin/poly(meth)acrylates are described for example in EP372746, EP412389 and WO93/05188. DE3438645 discloses fluorocarbon resins for use in impregnating sprays.

Silicone compounds are likewise used as effective leather-treating agents. DD7286938 utilizes a silicone oil for leather fatliquoring in admixture with other components.

DE4139090 describes copolymers with silicone side chains for softening and hydrophobizing leather.

Carboxyl-functional siloxanes are disclosed in WO95/22627 as emulsifiers for emulsions for use in leather hydrophobization.

EP 350240 describes the surface finishing of leather goods using aqueous emulsions of copolymers containing silane groups.

DE2205143 describes mixtures of (a) 15-50 wt % of Ti(OR)₄ or Zr(OR)₄, or the corresponding hydrolysates, where R is a long-chain alkyl, with (b) 5-70 wt % of an MQ resin and (c) 15-80 wt % of a silicone oil and (d) 0.5-30 wt % of an aminoalkyl-substituted silane or siloxane for treatment of leather. The improvement of durably water-repellent properties is described.

DE4126975 describes impregnating and preserving agents based on fluorocarbon resins, fluorosilicones and/or organometallic compounds formulated in a volatile siloxane as solvent/dispersant.

The prior art products for leather treatment have the disadvantages that they are often difficult to process, do not have a positive enough effect on the handle properties and, in the case of fluorine compounds, are halogen-containing.

The problem addressed by the present invention was that of providing compounds for use in leather treatment which are easy to process and bestow a smooth and very pleasant handle on the leather without losing the beneficial effect of sustained hydrophobization.

### DESCRIPTION OF THE INVENTION

The mixture compositions according to the invention, which contain amino-functional siloxanes, hydrophobic particles and high molecular weight silicones, are described herein below by way of example without any intention to restrict the invention to these exemplary embodiments. Where ranges, general formulae or classes of compounds are indicated in what follows, they shall encompass not just the corresponding ranges or groups of compounds that are explicitly mentioned, but also all sub-ranges and sub-groups of compounds which are obtainable by extraction of individual values (ranges) or compounds. Where documents are cited in the context of the present description, their content shall fully belong to the disclosure content of the present invention. Where compounds, such as organomodified polysiloxanes for example, which may contain various structural units more than once, are described, these units can occur in these compounds in random distribution (random oligomer) or orderly (block oligomer).

Indications concerning the number of units in such compounds are to be understood as mean values averaged over all such compounds. Indicated percent (%) are all mass percent, unless otherwise stated.

It was found that, surprisingly, the herein below described mixture compositions of amino-functional siloxanes, hydrophobic particles and high molecular weight silicones remedy the disadvantages of the prior art and hence solve the problem addressed by the invention.

The present invention accordingly provides mixture compositions as described in the claims and the use thereof for leather care.

The mixture compositions of the present invention have the advantage that they are inexpensive compositions which are simple to prepare.

A further advantage is that the mixture compositions of the present invention are very simple to process and use.

It is yet a further advantage that the mixture compositions of the present invention can be applied to leather in a very homogeneous manner.

The mixture compositions of the present invention are further advantageous because of their outstanding results in respect of the handle properties and the lustre on leather.

A further advantage of mixture compositions according to the present invention is the fact that they and the formulations prepared therewith have extended stability in storage.

Another advantage of mixture compositions according to the present invention is the fact that they provide outstanding hydrophobization of leather.

A further advantage of mixture compositions according to the present invention is the fact that the leather hydrophobization they provide is sustained and has a high resistance to cleaning.

The present invention provides mixture compositions containing
A) 50 wt %-96.5 wt %, preferably 65 wt %-96.5 wt %, of at least one amino-functional siloxane,
B) 3 wt %-40 wt %, preferably 3 wt %-30 wt %, of at least one high molecular weight silicone, and
C) 0.5 wt %-10 wt %, preferably 0.5 wt %-5 wt %, of hydrophobic particles, wherein the weight percentages are based on the sum of components A), B) and C).

The term “amino-functional siloxane” is to be understood in connection with the present invention as meaning a siloxane which has at least one amino group. Amino group comprehends primary, secondary or tertiary amino groups and also ionic adducts thereof with a protic reactant H⁺A⁻.

The term “high molecular weight silicone” is to be understood in connection with the present invention as meaning a silicone which has an average molecular weight of at least 20 000 g/mol.

The term “hydrophobic particle” is to be understood in connection with the present invention as meaning organic or inorganic particles having a methanol wettability above 50%.

An analytical method of determining methanol wettability can be carried out for example as follows: Transparent centrifuge tubes are each filled with 0.2 g (±0.005 g) of particles for which methanol wettability is to be determined. Each tube is then admixed with 8.0 ml of a methanol/water mixture containing respectively 10, 20, 30, 40, 50, 60, 70 and 80 vol % of methanol. The sealed tubes are shaken for 30 seconds and then centrifuged at 2500 min⁻¹ for 5 minutes. The sediment volumes are read off, arithmetically converted into percent and graft against the methanol content (vol %). Methanol wettability corresponds to the curve's point of inflection.

Conditions such as pressure and temperature for example are all, unless otherwise stated, standard conditions (25° C., 1 bar). Percentages are by mass, unless otherwise stated.

The amino group of the amino-functional siloxane can be attached side-on and/or end-on (alpha,omega-modification) to the siloxane skeleton.

The amino-functional siloxane of component A) is preferably an amino-functional siloxane of general formula 1:

MₐM′_{b}D_{c}D′_{d}TₑT′_{f}Q_{g} (general formula 1)

with

M=[R²R¹₂SiO_{1/2}]

M′=[R³R¹₂SiO_{1/2}]

D=[R²R¹SiO_{2/2}]

D′=[R³R¹SiO_{2/2}]

T=[R¹SiO_{3/2}]

T′=[R³SiO_{3/2}]

Q=[SiO_{4/2}],

where
R¹ represents independently in each occurrence identical or different linear or branched, saturated or unsaturated hydrocarbon moieties of 1 to 30 carbon atoms or else aromatic hydrocarbon moieties of 6 to 30 carbon atoms, preferably methyl or phenyl, especially methyl;
R² in each occurrence is the same or different and independently represents R¹, an alkoxy moiety or a hydroxyl group, preferably R¹, especially methyl;
R³ in each occurrence is the same or different and independently represents a linear or branched hydrocarbon moiety substituted with nitrogen atoms, preferably a moiety of the formulae —(CH₂)₃—NR⁴₂, —CH₂—CHMe—CH₂—NR⁴₂ or —(CH₂)₃NR⁴—(CH₂)₂NR⁴₂; especially —(CH₂)₃—NH₂ or —(CH₂)₃NH—(CH₂)₂NH₂;
R⁴ independently in each occurrence represents identical or different linear or branched, saturated or unsaturated hydrocarbon moieties of 1 to 22 carbon atoms, preferably ethyl or methyl, especially methyl;
a=0 to 20, preferably 0 to 10, especially 0 or 2,
b=0 to 20, preferably 0 or 2,
c=101 to 5000, preferably 170 to 2000, especially 250 to 1600,
d=0 to 500, preferably 0 to 100, especially 0 or 2 to 30,
e=0 to 20, preferably 0 to 10, especially 0,
f=0 to 20, preferably 0 to 10, especially 0,
g=0 to 20, preferably 0 to 10, especially 0,
   with the proviso that at least one of the indices b, d and f is ≠0.

In a preferred embodiment, at least 50%, preferably at least 70% of the R² moieties are=R¹.

Corresponding examples of amino-functional siloxanes are commercially available on the market from almost all silicone producers, for example DC 2-8566 (Dow Corning), SF 1708 (Momentive), KF-8015 or KF-8008 (Shin-Etsu). These are obtainable via equilibration or condensation in a known manner, for example as described in EP1972330 (sections 0154 and 0155), U.S. Pat. No. 7238768 and DE102010062676.

Especially halogen-free compounds are used as high molecular weight silicones of component B).

A high molecular weight silicone of component B) has a molecular weight average Mw of at least 20 000 g/mol, preferably 50 000 g/mol, more preferably at least 100 000 g/mol.

The average molecular weight Mw of the high molecular weight silicone can be determined using gel permeation chromatography (GPC). This involves calibration in the generally customary manner against, for example, commercial polystyrene standards having different molar masses (see also the DIN 55072-1/ISO 13885-1 standard).

The high molecular weight silicone of component B) is preferably a high molecular weight silicone and has a high viscosity; more particularly, its viscosities are preferably at least 50 000 mPa·s, more preferably at least 70 000 mPa·s, and even more preferably at least 100 000 mPa·s, measured at 25 ° C. The viscosity of the high molecular weight silicone can be determined using a rheometer at a shear rate of 10 s⁻¹ at25° C.

High molecular weight silicones which are preferred in the present invention are selected from the group of linear silicone oils, which preferably have an average molecular weight of more than 50 000 g/mol, or from the group of branched silicone resins, which preferably have a viscosity of more than 20 000 mPa·s, measured at 25° C.

Preferred silicone oils are selected from the group of methyl and/or phenyl-substituted and optionally also hydroxyl-terminated polysiloxanes having average molecular weights of more than 50 000 g/mol. Particular preference for use as high molecular weight silicone of component B) is given to dimethylpolysiloxane oils having viscosities of >100 000 cSt , measured at 25° C.

Examples of preferred high molecular weight silicone oils are the commercially available products SS4267 or Baysilone-Oel M 2000000 (Momentive), KF-96H-300000 (Shin-Etsu), PMX-200 Silicone Fluid, 500000 cSt. (Dow Corning) and Rhodorsil 0147 V 300000 (Bluestar). Examples for preferred hydroxyl-terminated polysiloxanes (PDM siloxanes) are the products Bays. Abhaesive/Release Coat. ZW PR/OH (Momentive) or UC 107 (UChem) which are commercially available under CAS number 70131-67-8.

Preferred branched silicone resins consist essentially of R⁵₂R⁶SiO₁₂ (“M”)- and SiO_{4/2} (“0”) and/or R⁶SiO3/2 (“T”) units,

where
R⁵ in each occurrence may be the same or different and represents a hydrogen atom or a monovalent, optionally substituted, optionally unsaturated SiC-bonded hydrocarbon moiety of 1 to 16 carbon atoms, preferably methyl, and
R⁶ has the meaning of R⁵ or represents an alkoxy rest with 1 to 4 carbon atoms or hydroxyl.

These resins are also called “MO” or “MT” resins. The molar ratio of M to Q and T units (M/(Q+T)) is preferably in the range from 0.5/1 to 1.5/1 and especially in the range from 0.5/1 to 1.0/1; the quotient of T to M units is preferably in the range from 0/1 to 0.4/1, especially 0/1. These silicone resins may additionally contain up to 10 wt % of hydroxyl or alkoxy groups.

Examples of preferred silicone resins are the commercially available products PA 51 (Dow Corning) or Wacker MQ 803 TF (Wacker).

High molecular weight silicones are obtainable as described for example in W. Noll, “Chemie and Technologie der Silicone”, Verlag Chemie, Weinheim, 1968.

High molecular weight silicones are also obtainable directly in an emulsion by condensing low molecular weight organosilicon compounds, as described in

EP 0093310 B2 for example.

In the context of the present invention, the emulsions thus obtained can also be mixed directly with A) and C) to obtain the mixture composition of the present invention.

Component C) preferably comprises hydrophobic particles having a particle size distribution maximum in the range of 0.5-30 μm, preferably 0.7-15 μm, and especially 0.8-11 μm.

Component C) preferably comprises hydrophobic particles having a methanol wettability above 55%, preferably above 60%, more preferably above 65% and especially above 70%.

Particle size distribution can be determined using for example a measuring system from Sympatec, consisting of the modules VIBRI, RODOS and HELOS. The particles are predispersed by vibration and dispersed, by blowing through a measuring chamber, by compressed air, preferably at an overpressure of 2 to 3 bar. In the measuring chamber, laser diffraction is used to determine the particle size distribution. Evaluation is done using the associated WINDOX software.

Suitable inorganic particles are hydrophobic or hydrophobized metal oxides such as silicas and alumina, metal soaps, alkaline earth metal carbonates or similar finely divided solids known from the prior art. Useful finely divided organic substances include known alkaline earth metal salts of long-chain fatty acids having 12 to 22 carbon atoms, the amides of these fatty acids, micronized waxes such as, for example, polyethylene waxes, PTFE waxes and copolymers thereof, and also mixtures of such waxes that are solid under conditions of use. It is similarly possible to use oligo-ureas as described in DE 19917186 by way of example.

Particularly suitable hydrophobic particles are hydrophobized metal oxides such as silicas or alumina, especially with a methanol wettability of above 55%, and organic waxes with melting point>80° C.

Preferred hydrophobized metal oxides are hydrophobized pyrogenous silicas as marketed for example by EVONIK INDUSTRIES AG under the “AEROSIL R” brand name (e.g. AEROSIL R 972, AEROSIL R 805, AEROSIL R 8200, AEROSIL RX 200). Examples of preferred organic waxes are polyethylene-based waxes (LANCO WAX PE 1544, LUBRIZOL), amide waxes (e.g. LICOWAX C P, CLARIANT) and also partially fluorinated waxes (such as VESTOWAX FM 1012, EVONIK INDUSTRIES).

Particular preference for the purposes of the present invention is given to mixture compositions wherein component A) is selected from amino-functional siloxanes of formula 1 where R¹ represents methyl and R³ represents —(CH₂)₃—NH₂ or —(CH₂)₃NH—(CH₂)₂NH₂, and component B) is selected from the group of methyl- and/or phenyl-substituted and optionally also hydroxyl-terminated polysiloxanes having average molecular weights of more than 50 000 g/mol, or from the group of branched silicone resins consisting essentially of R⁵₂R⁶SiO_{1/2} (“M”)- and SiO_{4/2} (“Q”)- and/or R⁶SiO3/2 (“T”) units, where R⁵ represents methyl and the molar ratio M to Q and T units (M/(Q+T)) is in the range from 0.5/1 to 1.5/1 and also the quotient of T to M units is in the range from 0/1 to 0.4/1, and component C) is selected from hydrophobic particles having a particle size distribution maximum in the range of 0.7-15 μm and a methanol wettability of above 55%.

The mixture compositions of the present invention are very useful for leather care and for producing leather care formulations. Bags, shoes, leather apparel, hats, furniture and leather seats are exemplary leather goods.

Accordingly, uses of this type likewise form part of the subject matter of the present invention as are the leather care formulations containing at least one mixture composition of the present invention for leather themselves.

The term “care formulation” is herein to be understood as meaning a formulation that fulfils the purpose of maintaining an article in its original form, to reduce or avoid the effects of external influences (e.g. time, light, temperature, pressure, soiling, chemical reaction with other reactive compounds coming into contact with the article) such as, for example, ageing, soiling, material fatigue, dulling, embrittlement, fading, or even to improve desired positive properties of the article. The lustre of said article may be mentioned as an example of the last point.

Preferred leather care formulations are shoe creams, impregnating agents or leather cleaners.

The care formulations of the present invention are preferably in the form of aqueous dispersions, especially emulsions.

In this case, the care formulations of the present invention preferably contain water, at least one emulsifier and optionally at least one organic solvent and optionally at least one preservative.

Preferred emulsifiers in this context are selected from fatty alcohol ethoxylates and polyglycerol esters; especially fatty alcohol ethoxylates. Examples of useful emulsifiers are representatives of the Tergitol product line from Dow Chemicals, for example Tergitol 15-S-7, Tergitol TMN-6 or Tergitol 15-S-5.

Preferred care formulations of the present invention additionally contain one or more ingredients from the group of surfactants, builders, perfumes, perfume carriers, dyes, antimicrobials, germicides, fungicides, antioxidants, preservatives, corrosion inhibitors, other phobizing and impregnating agents, no-swell and no-slip agents, neutral filling salts and also UV absorbers.

More particularly, the leather care formulations of the present invention may contain 0.001 to 90 wt %, more preferably 0.01 to 45 wt % of one or more of the further ingredients mentioned herein, in which case the wt % are based on the overall formulation.

Examples of useful surfactants are described in WO 2007/115872, page 17 line 28 to page 21 line 24. Examples of builders are described in WO 2007/115872, page 22 line 7 to page 25 line 26. Examples of antimicrobials, germicides, fungicides, antioxidants, preservatives and UV absorbers are described in WO 2007/115872 at page 28 line 14 to page 30 line 22. Their explicit disclosure content in this regard is hereby incorporated by reference.

The amounts of particular ingredients in the formulation of the present invention depend on the intended use.

Typical recipes for the particular uses are known prior art and are contained for example in the brochures of the producers of the particular base components and benefit agents. These existing formulations can generally be used in unchanged form. But if necessary the desired modifications for adaptation and optimization can be effected without complications by performing simple tests.

Illustrative embodiments of the present invention will now be more particularly described by way of example without any intention to restrict the invention, the scope of which is apparent from the entire description and the claims, to the exemplified embodiments.

### EXAMPLES

### Example 1

### Mixture of Amino-Functional Polydimethylsiloxane of Formula II with a 300 000 cSt silicone oil and Aerosil® RX 200:

79% of an amino-functional polydimethylsiloxane of formula II (prepared like Example 4 of DE102010062676.7 but without guanidine-modified silane) is mixed with 18% of a polydimethylsiloxane having a viscosity of 300 000 cSt (Rhodorsil ÖI 47 V 300000, Bluestar) and with 3% of a hydrophobized silica (Aerosil® RX 200, Evonik Industries AG).

Me₃SiO4-[Me₂SiO]₃₅₀-[MeRSiO]₇—SiMe₃, R═—(CH₂)₃—NH₂ (Formula II)

### Example 2

### Mixture of Amino-Functional Polydimethylsiloxane of Formula III with an Emulsion of 300 000 cSt Silicone Oil and Vestowax® FM 1012

A homogenizer is used to produce an emulsion from 25 parts of a polydimethylsiloxane having a viscosity of 300 000 cSt (Rhodorsil ÖI 47 V 300000, Bluestar), 5 parts of a micronized hard wax (Vestowax® FM 1012, Evonik Industries AG), 17 parts of Tergitol 15-S-7 (Dow Chemicals) emulsifier and 20 parts of water, and the emulsion is mixed with 70 parts of an aminopropyl-functional polydimethylsiloxane of formula III (prepared similarly to Example 4 of DE102010062676.7 but without guanidino-modified silane and with Dynasylan® 1411 (Evonik Industries AG)).

Me₃SiO-[Me₂SiO]₁₀₀₀-[MeRSiO]₂₀—SiMe₃, R=—(CH₂)₃—NH—(CH₂)₂—NH₂ (Formula III)

### Example 3

### Mixture of Amino-Functional Polydimethylsiloxane of Formula IV with a 200 000 cSt Silicone Oil and Aerosil® RX 200:

75% of an amino-functional polydimethylsiloxane of formula IV (prepared via alkaline equilibration from 1,3-bis(aminopropyl)tetramethyldisiloxane and decamethylcyclopentasiloxane D5) is mixed with 22% of a polydimethylsiloxane having a viscosity of 100 000 cSt (KF-96L-100,000, Shin-Etsu) and with 3% of a hydrophobized silica (Aerosil® RX 200, Evonik Industries AG).

RMe₂SiO-[Me₂SiO]₃₅₀—SiMe₂R, R=—(CH₂)₃—NH₂ (Formula IV)

### Example 4

### Mixture of Amino-Functional Polydimethylsiloxane of Formula V with a PA 51 MO Resin and Aerosil® RX 200:

69% of an amino-functional polydimethylsiloxane of formula V (prepared similarly to Example 4 of DE102010062676.7 but without guanidine-modified silane and with

Dynasylan 1411 (Evonik Industries AG)) is mixed with 26% of an MQ resin (PA 51, Dow Corning) and with 5% of a hydrophobized silica (Aerosil® RX 200, Evonik Industries AG).

Me₃SiO -[Me₂SiO]₄₀₀-[MeRSiO]₁₀—SiMe₃, R=—(CH₂)₃—NH—(CH₂)₂—NH₂ (Formula V)

### Comparative Example 5 (Not in Accordance with the Present Invention)

Mixture as for Example 1 but without Aerosil® RX 200.

### Comparative Example 6 (Not in Accordance with the Present Invention)

Mixture as for Example 1 but without 300 000 cSt silicone oil and without Aerosil® RX 200.

### Comparative Example 7 (Not in Accordance with the Present Invention)

Mixture as for Example 1 but without 300 000 cSt silicone oil.

### Performance Characteristics

The product examples described above were herein below tested for use on leather. Examples 1-7 were for this purpose diluted with white spirit to 10% actives (aminosiloxane+silicone oil+hydrophobic particles). Of the solutions/mixtures obtained, 1 g was uniformly brushed onto 2 g of grained, full-chrome shoe leather. The treated leather samples were allowed to dry under policed conditions (23° C., 50% relative humidity) for 3 days.

An expert panel made up of 4 people subsequently assessed the handle properties of the leather (ratings from 1=poor to 5=very good). The summarised results are shown in Table 1.

TABLE 1
Assessment of handle properties of treated leather samples.

| | Softness | Smoothness | Fatness | Lustre |
|---|---|---|---|---|
| Example 1 | 4.0 | 4.2 | 3.9 | 3.2 |
| Example 2 | 4.0 | 4.3 | 3.9 | 3.1 |
| Example 3 | 4.2 | 4.3 | 4.0 | 3.4 |
| Example 4 | 4.1 | 4.4 | 3.9 | 3.1 |
| Comparative Example 5 | 3.1 | 3.4 | 3.7 | 2.8 |
| Comparative Example 6 | 2.5 | 2.4 | 3.0 | 2.8 |
| Comparative Example 7 | 2.8 | 2.6 | 3.0 | 2.6 |

The results of the panel test show that, surprisingly, Inventive Examples 1 to 4 did better than Comparative Examples 5, 6 and 7 on all handle properties of the leather. The positive effect of the mixtures of the present invention is very clear with regard to leather softness and smoothness specifically.

Further formulation examples:

TABLE.2
Mixtures used for leather treatment as 10% dilutions with white spirit for example.

| | a | b | c | d | e | f | g | h | i | j |
|---|---|---|---|---|---|---|---|---|---|---|
| aminosiloxane of formula II | 59% | | | | | | 10% | 40% | | |
| aminosiloxane of formula III | | 95% | | | | | | | 10% | |
| aminosiloxane of formula IV | | | 80% | | | | 65% | | 50% | 45% |
| aminosiloxane of formula V | | | | 70% | | | | 35% | | 30% |
| KF-8015 (Shin-Etsu) aminosiloxane | | | | | 85% | | | | 5% | |
| SF 1708 (Momentive) aminosiloxane | | | | | | 75% | | | | 5% |
| Rhodorsil OI 47 V 300000 (Bluestar) silicone | | 3% | | | | | 9% | | | 5% |
| oil | | | | | | | | | | |
| KF-96L-100,000 (Shin-Etsu) silicone oil | 17% | | | | | 15% | | 16% | 10% | |
| Baysilone-Oel M 2000000 (Momentive) | | | 19% | | | | | | | |
| silicone oil | | | | | | | | | | |
| Bays. Abhaesive/Release Coat. ZW PR/OH | | | | 28% | | | | 5% | | |
| (Momentive) PDM siloxane | | | | | | | | | | |
| PA 51 (Dow Corning) MQ resin | | | | | 12% | | | | 5% | 10% |
| Wacker MQ 803 TF | | | | | | 5% | | | | 1% |
| LANCO WAX PE 1544 (Lubrizol) PE wax | | | 1% | | | | | | 1.5% | |
| AEROSIL ® R 972 (Evonik) hydrophobized | | 2% | | | | 1% | | | | 1% |
| silica | | | | | | | | | | |
| LICOWAX C P (Clariant) amide wax | 5% | | | | | | | | | 0.5% |
| VESTOWAX ® FM 1012 (Evonik) micronized | | | | 2% | | | 3% | 1% | 2.5% | |
| hard wax | | | | | | | | | | |
| AEROSIL ® RX 200 (Evonik) hydrophobized | | | | | 3% | 4% | | 3% | 1% | 2.5% |
| silica | | | | | | | | | | |
| Tergitol 15-S-7 (Dow Chemicals) | 7.5% | | | | | | 5.5% | | 6% | |
| water | 11% | | | | | | 7% | | 8.5% | |
| Acticide MBS preservative | 0.5% | | | | | | 0.5% | | 0.5% | |

1. A mixture composition comprising:
A) 50 wt % -96.5 wt % of at least one amino-functional siloxane,
B) 3 wt% -40 wt% of at least one high molecular weight silicone having a molecular weight average of at least 20,000 g/mol, and
C) 0.5 wt % -10 wt % of hydrophobic particles, wherein the weight percentages are based on total components A), B) and C).

2. A mixture composition according to claim 1 as wherein said at least one amino-functional siloxane is a compound of general formula 1:
MₐM′_{b}D_{c}D′_{d}TₑT′_{f}Q_{g} (general formula 1)
with
M=[R²R¹₂SiO_{1/2}]
M′=[R³R¹₂SiO_{1/2}]
D=[R²R¹SiO_{2/2}]
D′=[R³R¹SiO_{2/2}]
T=[R¹SiO_{3/2}]
T′=[R³SiO_{3/2}]
Q=[SiO_{4/2}],
where
R¹ represents independently in each occurrence identical or different linear or branched, saturated or unsaturated hydrocarbon moieties of 1 to 30 carbon atoms or aromatic hydrocarbon moieties of 6 to 30 carbon atoms;
R² in each occurrence is the same or different and independently represents R¹, an alkoxy moiety or a hydroxyl group;
R³ in each occurrence is the same or different and independently represents a linear or branched hydrocarbon moiety substituted with nitrogen atoms;
R⁴ independently in each occurrence represents identical or different linear or branched, saturated or unsaturated hydrocarbon moieties of 1 to 22 carbon atoms;
a=0 to 20,
b=0 to 20,
c=101 to 5000,
d=0 to 500,
e=0 to 20,
f=0 to 20,
g=0 to 20,
with the proviso that at least one of the indices b, d and f is ≠0.

3. A mixture composition according to claim 2, wherein at least 50% of the R² moieties are=R¹.

4. A mixture composition according to claim 1, wherein said at least one high molecular weight silicone is selected from the group consisting of linear silicone oils and branched silicone resins.

5. A mixture composition according to claim 1, wherein said hydrophobic particles have having a particle size distribution maximum in a range from 0.5-30 μm.

6. A mixture composition according to claim 1, wherein said hydrophobic particles are selected from hydrophobic or hydrophobized metal oxides, metal soaps, alkaline earth metal carbonates and alkaline earth metal salts of long-chain fatty acids having 12 to 22 carbon atoms, amides of said fatty acids, micronized waxes, and oligo-ureas.

7. A mixture composition according to claim 2, wherein
R¹ of formula (I) represents methyl and R³ of formula (I) represents —(CH₂)₃—NH₂ or —(CH₂)₃NH—(CH₂)₂NH₂, and
component B) is selected from the group of methyl- and/or phenyl-substituted having average molecular weights of more than 50 000 g/mol, or from the group of branched silicone resins consisting essentially of R⁵₂R⁶SiO_{1/2} (“M”)- and SiO_{4/2}(“Q”)- and/or R⁶SiO3/2 (“T”) units, where R⁵ represents methyl and the molar ratio M to Q and T units (M/(Q+T)) is in a range from 0.5/1 to 1.5/1 and also the quotient of T to M units is in a range from 0/1 to 0.4/1, and
component C) is selected from hydrophobic particles having a particle size distribution maximum in the range of 0.7-15 μm and a methanol wettability of above 55%.

8. A method of treating a leather product, said method comprising applying a mixture composition to said leather product, said mixture composition comprising:
A) 50 wt %-96.5 wt % of at least one amino-functional siloxane,
B) 3 wt %-40 wt % of at least one high molecular weight silicone having a molecular weight average of at least 20,000 g/mol, and
C) 0.5 wt %-10 wt % of hydrophobic particles,
wherein the weight percentages are based on total components A), B) and C).

9. (canceled)

10. A leather care formulation comprising the mixture composition of claim 1.

11. The leather care formulation according to claim 10, wherein said formulation comprises an aqueous dispersion containing said mixture composition.

12. The leather care formulation according to claim 1, further
comprising water and
at least one emulsifier.

13. The leather care formulation according to claim 12, wherein said at least one emulsifier is selected from fatty alcohol ethoxylates and polyglycerol esters.

14. The leather care formulation according to claim 12, further comprises at least one organic solvent, at least one preservative or both at least one organic solvent and at least one preservative.
